(19) United States
(12) Patent Application Publication
(10) Pub. No.: US 2011/0210100 A1
(43) Pub. Date: Sep. 1, 2011

(54) CONTROLLABLE CUT BY A PLASMA ARC TORCH

(75) Inventors: Robert L. Smallwood, Florence, SC (US); Joseph V. Warren, JR., Florence, SC (US)

(73) Assignee: The ESAB Group, Inc.

(21) Appl. No.: 12/715,069

(22) Filed: Mar. 1, 2010

(51) Int. Cl. B23K 10/00

(52) U.S. Cl. 219/121.44

(57) ABSTRACT

Embodiments of methods of controlling the shape of a cut on a workpiece using a plasma arc torch are provided. The methods may control the resultant cut angle and the shape of a top of the cut. The top of the cut can have either a sharp edge, or have a rounded lip. The radius of the rounded lip can be adjusted. The standoff distance defined between the nozzle of the plasma arc torch and the top surface of the workpiece contributes to defining the resultant cut angle and the shape of the top of the cut. In particular, increasing the standoff results in a greater radius and increases the cut angle and decreasing the standoff distance does the opposite. Additionally, the angle of inclination of the plasma arc torch can be used to compensate for a resultant cut angle so as to produce a desired cut angle.

### BACKGROUND OF THE INVENTION

1. Field of the Invention

The present invention relates to plasma arc torches and, more particularly, to an apparatus and method for controlling the resultant angle and shape of the top of a cut on a workpiece using a plasma arc torch.

2. Background of the Invention

Plasma arc torch cutting apparatuses have advanced in recent years to enable control of a variety of factors affecting cuts created by plasma arc torches. Such factors may include, among others, selection of a plasma gas and a shield gas, flow rate of the plasma gas and shield gas, standoff distance, arc power, relative speed of movement of the plasma arc torch with respect to a workpiece, and angle of inclination of the plasma arc torch. Further, control systems have enabled automatic selection of such factors for different types of uses of plasma arc torches, such as marking, high-speed cutting, and high-quality cutting, depending on the specifications of the workpiece being processed, such as the type of material and the thickness thereof.

### BRIEF SUMMARY OF THE DISCLOSURE

In various embodiments described herein, a method of forming a cut through a workpiece by a plasma arc torch may comprise selecting a standoff distance defined between the workpiece and an end of a nozzle of the plasma arc torch, and cutting through the workpiece with the plasma arc torch at the selected standoff distance so as to produce a rounded lip at a top of the cut having a radius substantially matching a desired radius, and selecting a non-zero angle of inclination between a center axis of the plasma arc torch and a normal to a top surface of the workpiece. The cutting step may be performed with the torch oriented at the selected angle of inclination so as produce a resultant cut angle substantially matching a desired cut angle.

In other embodiments, the step of selecting the angle of inclination may comprise selecting a test angle of inclination; cutting through the workpiece with the torch oriented at the test angle of inclination, and determining the resultant cut angle produced; and adjusting the test angle of inclination by an adjustment angle to compensate for any difference between the desired cut angle and the resultant cut angle. Further, the test angle may be substantially zero with respect to the normal to the top surface of the workpiece, and the adjustment angle may be equal in magnitude to the resultant cut angle but opposite in direction with respect to the normal to the workpiece. Additionally, the desired cut angle may be substantially zero with respect to the normal to the top surface of the workpiece. Also, the method may further comprise increasing the standoff distance to increase the radius of the lip. In addition, the method may further comprise increasing the standoff distance and increasing an arc power to increase the radius of the lip. The method may also further comprise increasing the standoff distance and decreasing a shield gas flow rate to increase the radius of the lip. Further, the method may additionally comprise decreasing the standoff distance to decrease the radius of the lip. The method may further comprise decreasing the standoff distance and decreasing the arc power to decrease the radius of the lip. Additionally, the method may also further comprise decreasing the standoff distance and increasing the shield gas flow rate to decrease the radius of the lip. Also, the selected angle of inclination and standoff distance may cause the resultant cut angle to have a non-zero magnitude with respect to the normal to the top surface of the workpiece.

In other various embodiments a method of cutting through a workpiece with a plasma arc torch so as to produce a rounded lip facilitating adhesion of a coating thereto may comprise cutting with the plasma arc torch set at a selected standoff distance between an end of a nozzle of the plasma arc torch and the workpiece so as to give the rounded lip a radius substantially matching a desired radius. This method may further comprise tilting the plasma arc torch at an angle of inclination, so as to produce a resultant cut angle substantially matching a desired cut angle. The angle of inclination compensates for any difference between the desired cut angle and the resultant cut angle that would otherwise be produced with the torch normal to the workpiece.

In additional embodiments, a method of cutting through a workpiece with a plasma arc torch so as to produce a resultant cut angle defined with respect to a normal to a top surface of the workpiece may comprise cutting with the plasma arc torch set at a selected standoff distance between an end of a nozzle of the plasma arc torch and the workpiece so as to substantially match the resultant cut angle with a desired cut angle. The method may further comprise increasing the standoff distance to increase a magnitude of the resultant cut angle. Additionally, the method may further comprise increasing the standoff distance and increasing the arc power to increase the magnitude of the resultant cut angle. The method may additionally further comprise increasing the standoff distance and decreasing the shield gas flow rate to increase the magnitude of the resultant cut angle. Also, the method may comprise decreasing the standoff distance to decrease a magnitude of the resultant cut angle. The method may additionally comprise decreasing the standoff distance and decreasing an arc power to decrease the magnitude of the resultant cut angle. Further, the method may comprise decreasing the standoff distance and increasing the shield gas flow rate to decrease the magnitude of the resultant cut angle.

### BRIEF DESCRIPTION OF THE SEVERAL VIEWS OF THE DRAWING(S)

Having thus described the embodiments in general terms, reference will now be made to the accompanying drawings, which are not necessarily drawn to scale, and wherein:

FIG. 1 is a side view of a plasma arc torch at a zero degree angle of inclination and with a relatively small standoff distance, which creates a sharp edge at the top of a cut which has a resultant cut angle substantially normal to the top surface of the workpiece;

FIG. 2 is a side view of a plasma arc torch at a zero degree angle of inclination and with a relatively large standoff distance, which creates a rounded lip having a radius at the top of the cut and a resultant cut angle which is offset from normal with the top surface of the workpiece;

FIG. 3 is a side view of a plasma arc torch at a non-zero angle of inclination and a relatively large standoff distance, which results in a rounded lip having a radius at the top of a cut and a resultant cut angle which is substantially normal to the top surface of the workpiece;

FIG. 4 illustrates a flow chart representation of methods for forming a cut through a workpiece having a desired radius and a desired cut angle;

FIG. 5 illustrates a flow chart representation of methods for cutting through a workpiece so as to facilitate adhesion of a coating thereto by producing a rounded lip on a cut having a desired radius;

FIG. 6 illustrates a flow chart representation of methods for producing a cut having a desired cut angle; and

FIG. 7 illustrates a block diagram of a system and method for cutting a workpiece using a plasma arc torch with a controller.

### DETAILED DESCRIPTION OF THE DRAWINGS

Apparatuses and methods for creating cuts in a workpiece now will be described more fully hereinafter with reference to the accompanying drawings, in which some, but not all embodiments are shown. Indeed, the present development may be embodied in many different forms and should not be construed as limited to the embodiments set forth herein; rather, these embodiments are provided so that this disclosure will satisfy applicable legal requirements. Like numbers refer to like elements throughout.

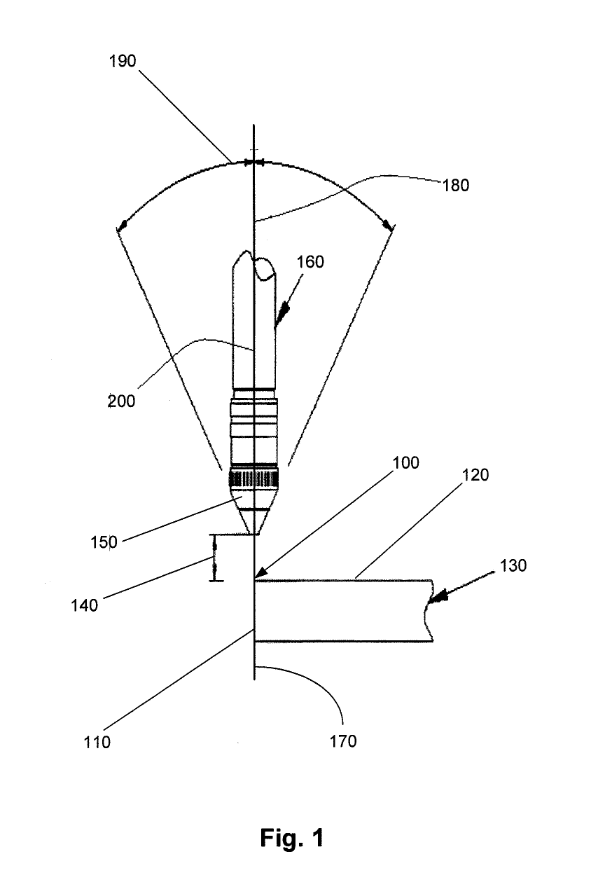

Many advances have been made in the art of plasma arc torches and controls therefore. These advances have focused primarily on apparatuses and methods for cutting sharp edges. FIG. 1 illustrates an apparatus capable of creating a sharp edge 100 at the top of a cut 110 in a workpiece 130. As a result of using a relatively small standoff distance 140, where the standoff distance is defined as the distance between the lower surface of the nozzle 150 of a plasma arc torch 160 and the top surface 120 of a workpiece 130, the plasma arc torch creates a cut 110 having a sharp edge 100 at the top of the cut. This cut 110 further has a resultant cut angle 170, defined with respect to, and in this case aligned with, a normal 180 to the top surface 120 of the workpiece 130. The use of the small standoff distance 140 allows the plasma arc torch 160 to have an angle of inclination 190, defined between the normal 180 to the top surface 120 of the workpiece 130, and a center axis 200 of the plasma arc torch, substantially aligned with the normal to the top surface of the workpiece while creating this type of cut. Thus, making such a cut 110 may not require altering the angle of inclination 190 despite advances in plasma arc torches 160 enabling this angle to be controlled.

As described above, advances in plasma arc torches 160 and control systems therefore (not shown) have made significant strides in apparatuses and methods for creating sharp edges 100 in workpieces 130. However, such advances have largely failed to explore methods of creating other useful cut shapes. In this regard, the methods described herein establish ways to control cut shapes created by plasma arc torches 160. In particular, the methods relate to control of the cut angle 170 as well as the shape of the top of the cut 110.

With regard to the top of a cut, a rounded lip can be advantageous for a variety of reasons. For example, a rounded lip may be created to address safety concerns, wherein the workpiece is potentially subject to human or other animal contact. In such situations, a rounded lip may be preferable to a sharp edge because a sharp edge may be more likely to cause injury. Additionally, in some applications, rounded lips may be considered aesthetically pleasing. Further, a rounded lip at the top of a cut may be used in certain objects to produce a more pleasurable tactile sensation, or to provide a better ergonomic shape for human grasping. Even further, from a manufacturing perspective, the creation of a rounded lip may aid in the adhesion of paint or other coating to the cut surface, whereas a sharp edge may be difficult to adhere to.

For at least the reasons stated above, a rounded lip may be preferable to a sharp edge at the top of a cut. While a rounded lip may be produced on some materials by sanding, grinding, or otherwise further processing a cut surface after the step of cutting a workpiece with a plasma arc torch, the methods disclosed herein may produce a rounded lip during the cutting of the workpiece with a plasma arc torch without requiring additional processing. Accordingly, a cut surface having a rounded lip at the top thereof may be produced without additional processing steps beyond the initial plasma arc torch cut.

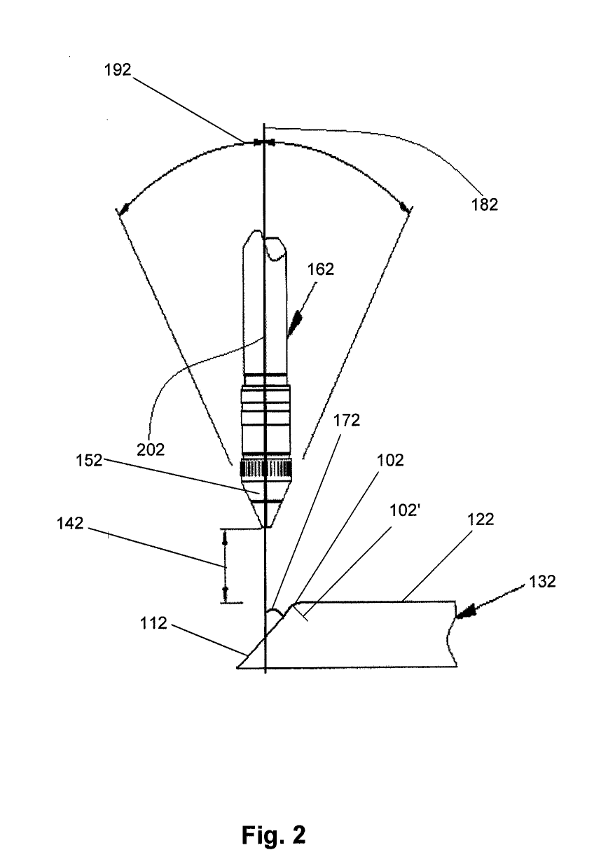

For the advantageous reasons described above, and in order to achieve other such benefits which may be envisioned, FIG. 2 illustrates an apparatus for producing a cut 112 having a rounded lip 102 at the top of the cut which acts as a transition between the surface of the cut and the top surface 122 of a workpiece 132. In order to produce a desired rounded lip 102 at the top of a cut 112, the standoff distance 142 between the workpiece 132 and the nozzle 152 of the plasma arc torch 162, may be selected to be a certain value. In this regard, it has been discovered that selecting a standoff distance 142 of a sufficiently large value for cutting using a plasma arc torch 162 results in the creation of a rounded lip 102 at the top of the cut 112.

Also, it has been discovered that by further increasing the standoff distance 142, the radius 102′ of the rounded lip 102 at the top of the cut 112 increases. Alternatively, by decreasing the standoff distance 142, the radius 102′ of the rounded lip 102 at the top of the cut 112 decreases. Thus, by varying the standoff distance 142, it is possible to change the resultant radius 102′ to obtain a desired radius.

However, it has further been discovered that adjusting the standoff distance affects the resultant cut angle 172 with respect to a normal 182 to the top surface 122 of the workpiece 132. As seen in FIG. 1, a relatively small standoff distance 140 may produce a resultant cut angle 170 which is substantially equal to the angle of inclination 190 of the center axis 200 of the plasma arc torch 160.

Referring once again to FIG. 2, it can be seen that increasing the standoff distance 142 results in the creation of a resultant cut angle 172 which may vary from the angle of inclination 192 of a center axis 202 of the plasma arc torch 162. In some instances it may be acceptable for the cut 112 to have a resultant cut angle 172 differing from the normal 182 to the top surface 122 of the workpiece 132 and further having a rounded lip 102 at the top of the cut. However, in some instances, a desired cut angle 172 may be closer or further from the normal 182 to the top surface 122 of the workpiece 132.

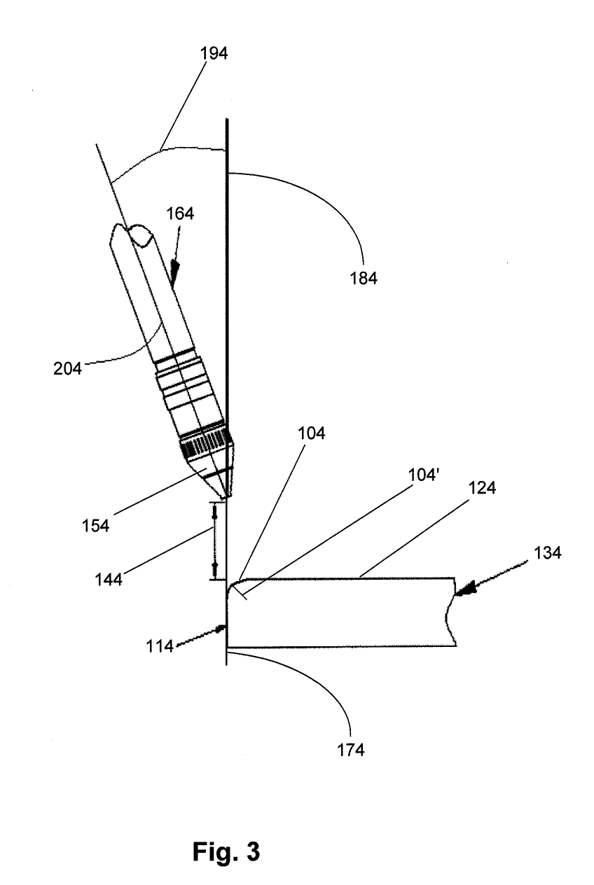

FIG. 3 thus illustrates another apparatus for creating a cut 114 in a workpiece 134. In particular, in some applications the desired cut angle 174 may be zero with respect to the normal 184 to the top surface 124 of the workpiece 134. While such an angle can be created using the relatively small standoff distance 140, as shown in FIG. 1, it may not be desirable to have a sharp edge 100, and thus additional steps may be required to avoid this result.

Accordingly, FIG. 3 further shows an apparatus capable of producing a resultant cut angle 174 which is substantially zero with respect to a normal 184 to the top surface 124 of the workpiece 134, and wherein the cut 114 further has a rounded lip 104 at the top of the cut, resulting from the relatively large standoff distance 144 between the nozzle 154 and the top surface of the workpiece. As seen, the selected angle of inclination 194 of the center axis 204 of the plasma arc torch 164 may be used to obtain a desired cut angle 174. Thus, this embodiment takes advantage of the ability of some plasma arc torches 194 and corresponding control systems (not shown) to adjust the angle of inclination 194 of the center axis 204 of the plasma arc torch.

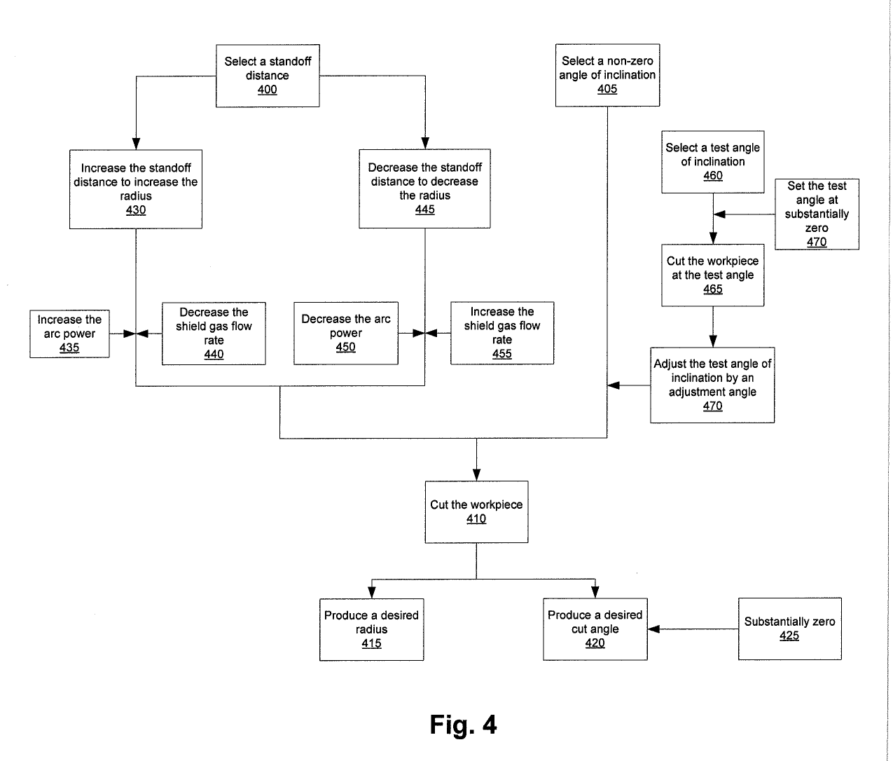

Having thus described the functionality of embodiments of apparatuses, reference will now be made to particular methods taking advantage of apparatuses such as the one shown in FIG. 3. In particular, FIG. 4 illustrates a flow chart representation of methods (with embodiments of example structures and angles described in terms of the reference numerals from FIG. 3) for forming a cut 114 through a workpiece 134 using a plasma arc torch 164. The method comprises a step 400 of selecting a standoff distance and a step 405 of selecting a non-zero angle of inclination prior to a workpiece cutting step 410, so as to produce a desired radius as shown at 415, and to produce a desired cut angle as shown at 420. The angle of inclination 194 is defined within this method, as it was defined before with respect to FIG. 3, as being between the center axis 204 of the plasma arc torch 164 and a normal 184 to the workpiece 134. Accordingly, as shown in FIG. 3, a cut 114 may include a rounded lip 104 with a desired radius 104′ and a desired cut angle 174. As shown in FIG. 4, in one embodiment, the method further comprises selecting the desired cut angle to be substantially zero as shown at step 425. As illustrated in FIG. 3, this results in a cut 114 having a cut angle 174, which is parallel with a normal 184 to the workpiece 134.

With regard to step 400 of selecting the standoff distance, the method can further comprise the step 430 of increasing the standoff distance to increase the radius. As described above, this particular result may be advantageous. Increasing the standoff distance 144 can increase the radius 104′ of a rounded lip 104 at the top of a cut 174. The step 430 of increasing the standoff distance may further include a step 435 of increasing the arc power, which may be used to over-burn the top edge to assist in producing the radius. The desired power will depend on the particular specifications of the workpiece 134 being cut. Such specifications include the thickness of the workpiece 134 and the type of material comprising it. Additionally, a step 440 of decreasing the shield gas flow rate may also be conducted in conjunction with the step 430 of increasing the standoff distance. This additional step may allow the flame produced by the plasma arc torch 164 to diverge and take the form of a cone shape, which may aid in the production of the rounded lip 104 having a radius 104′, as shown in FIG. 3.

Conversely, with further regard to the step 400 of selecting the standoff distance, the method can further comprise a step 445 of decreasing the standoff distance to decrease the radius. In particular, decreasing the standoff distance 144 can decrease the radius 104′ of a rounded lip 104 at the top of a cut 114. This step may further include an additional step 450 of decreasing the arc power, which may decrease the burn on the top of the cut 114 in order to further reduce the radius 104′, and which will depend on the specifications of the workpiece 134 being cut. As described above, such specifications include the thickness of the workpiece 134 and the type of material comprising it. Additionally, a step 455 of increasing the shield gas flow rate may also be conducted. This additional step may restrict flame divergence to prevent the flame from forming a cone shape, and which may thereby aid in reducing the size of a radius 104′ of a rounded lip 104. The step 450 of decreasing the arc power and the step 455 of increasing the shield gas flow rate may each be optional depending on the initial arc power and shield gas flow rate. Accordingly, in some embodiments of the method, the arc power and the shield gas flow rate may each remain constant while the standoff distance 144 is reduced and the method may still result in decreasing the radius 104′ of a rounded lip 104 at the top of a cut 114.

With regard to the step 405 of selecting a non-zero angle of inclination, this step can further comprise a step 460 of selecting a test angle of inclination, a step 465 of cutting the workpiece at the test angle, and a step 470 of adjusting the test angle of inclination by an adjustment angle. The adjustment angle thus compensates for any difference between desired and resultant cut angles 174 to produce a cut 114 having the desired cut angle. With regard to the step 460 of selecting a test angle of inclination, this step may further comprise a step 470 of setting the test angle at substantially zero. In this case, by first setting the angle of inclination 194 at a zero degree angle of inclination, the adjustment to the angle of inclination will be equal in magnitude to the resultant cut angle 174 resulting from the step 465 of cutting the workpiece at the test angle, but opposite in direction with respect to the normal 184 to the workpiece 134.

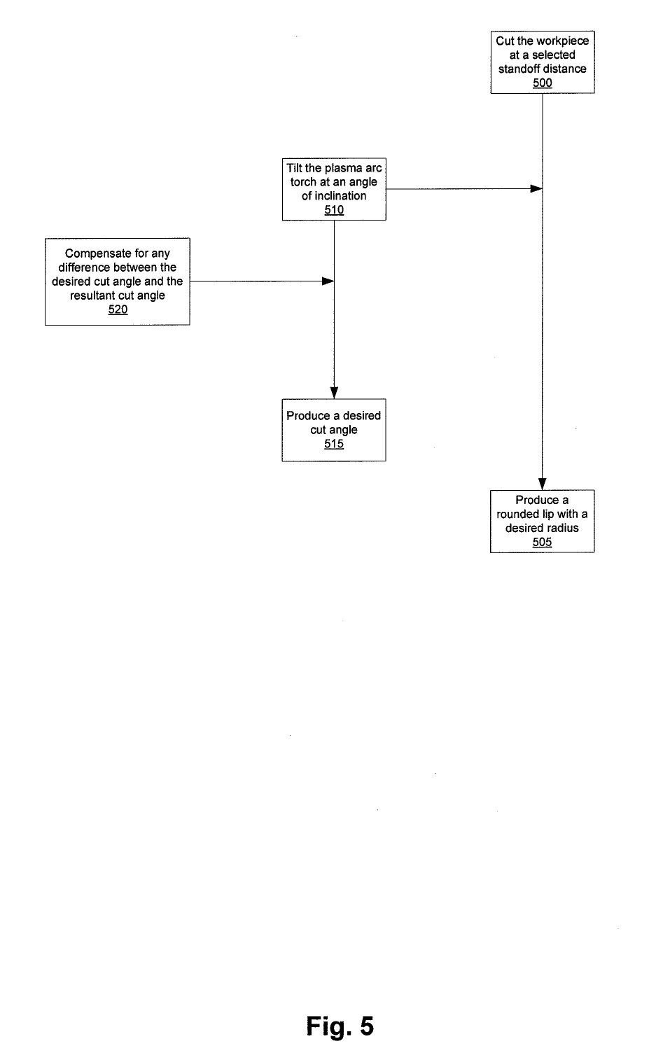

Referring now to FIG. 5, there is shown a method (with embodiments of example structures and angles herein described in terms of the reference numerals from FIG. 3) of cutting through a workpiece 134 with a plasma arc torch 164 so as to produce a rounded lip 104 facilitating adhesion of a coating thereto. The method can comprise a step 500 of cutting the workpiece at a selected standoff distance in order to produce a rounded lip with a desired radius, as shown at 505. The standoff distance 144 is defined within this method, as it was defined before with respect to FIG. 3, as being between the nozzle 154 of the plasma arc torch 164 and the workpiece 134. This method can further include a step 510 of tilting the plasma arc torch at an angle of inclination in order to produce a desired cut angle, as shown at 515. The angle of inclination 194 is defined within this method, as it was defined before with respect to FIG. 3, as being between the center axis 204 of the plasma arc torch 164 and a normal 184 to the workpiece 134. The step 510 of tilting the plasma arc torch at an angle of inclination may further comprise a step 520 of compensating for any difference between the desired cut angle and the resultant cut angle. For instance, as may be envisioned from FIG. 3, if an initial cut 114 does not have a desired cut angle 174, the angle of inclination 194 may be used to compensate for the difference between the desired and resultant cut angles.

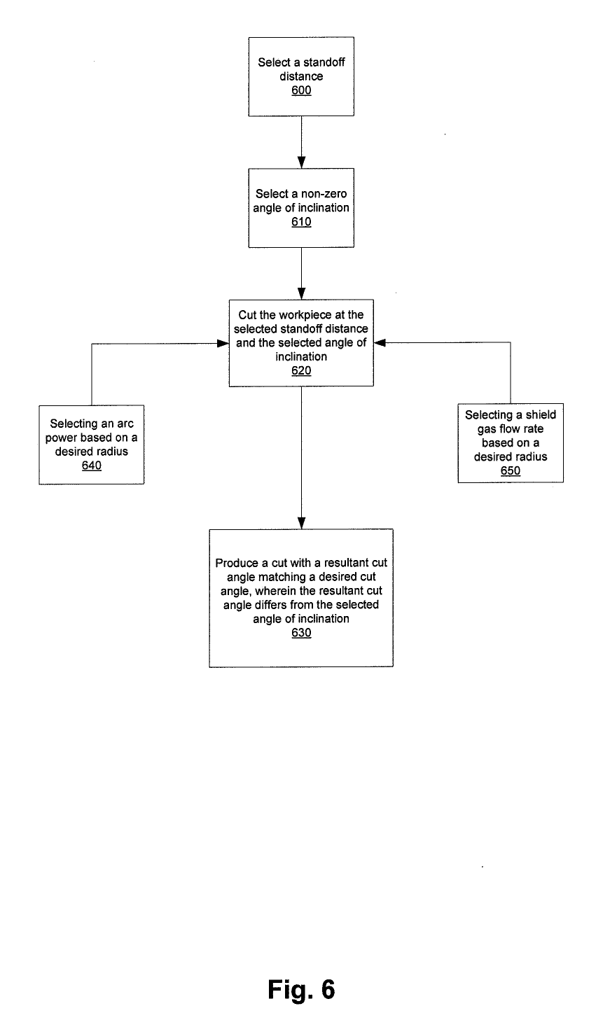

Referring now to FIG. 6, there is shown a method (with embodiments of example structures and angles herein described in terms of the reference numerals from FIG. 3) of cutting through a workpiece 134 with a plasma arc torch 164 so as to produce a cut 114 with a desired cut angle 174 defined with respect to a normal 184 to a top surface 124 of a workpiece 134. This method may comprise a step 600 of selecting a standoff distance between an end of a nozzle of the plasma arc torch and the workpiece. The method may further comprise a step 610 of selecting a non-zero angle of inclination. The angle of inclination 194 is defined within this method, as it was defined before with respect to FIG. 3, as being between the center axis 204 of the plasma arc torch 164 and a normal 184 to the workpiece 134. Additionally, the method may comprise a step 620 of cutting the workpiece with the plasma arc torch set at the selected standoff distance and oriented at the selected angle of inclination in order to produce a cut with a resultant cut angle matching a desired cut angle, wherein the resultant cut angle differs from the selected angle of inclination, as shown at 630. The method may further comprise a step 640 of selecting an arc power based on a desired radius. This step may aid in producing a desired radius 104′ at the top of the cut 114, as shown in FIG. 3. Also, the method may further comprise a step 650 of selecting a shield gas flow rate based on a desired radius. This step may also aid in producing a desired radius 104′ at the top of a cut 114, as shown in FIG. 3.

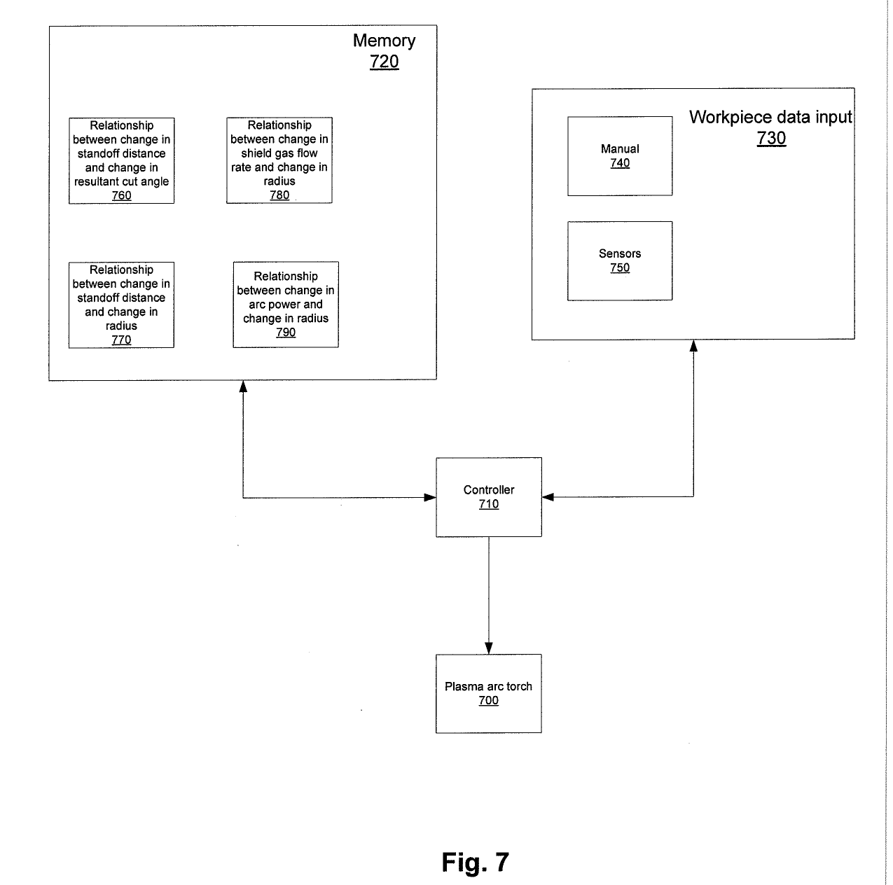

Referring now to FIG. 7, there is shown a system and method for cutting a workpiece using a plasma arc torch with a controller. The system may comprise a plasma arc torch 700, a controller 710, a memory 720, and a workpiece data input 730. In operation, the controller 710 may provide instructions which adjust certain parameters relating to the plasma arc torch 700. For example, the controller 710 may control a standoff distance, a shield gas flow rate, and an arc power. These parameters may be adjusted depending on the characteristics of the workpiece being cut. The controller 710 may receive a workpiece data input 730 which provides the controller with the characteristics of the workpiece being cut. The workpiece data input 730 may comprise a manual input 740, such as from entering the workpiece characteristics using a keyboard, or the workpiece characteristics can be determined automatically, such as through reading a workpiece identifier. For example, a sensor 750 may read a stored barcode which provides identification information corresponding to a workpiece having certain characteristics.

Accordingly, the controller 710 may search the memory 720 for relevant relationships between the parameters of the plasma arc torch 700 and a resulting cut in the workpiece having known characteristics. Thus, the controller 710 can adjust the parameters of the plasma arc torch 700 in order to result in the desired cut. For example, the memory 720 may store parameters relating to the relationship 760 between the change in the standoff distance and the change in the resultant cut angle, the relationship 770 between the change in the standoff distance and the change in a radius at the top of the cut, the relationship 780 between the change in the shield gas flow rate and the change in the radius at the top of the cut, and the relationship 790 between the change in the arc power and the change in the radius at the top of the cut. Accordingly, the controller 710 may change the parameters of the plasma arc torch 700 in order to create the desired cut in the workpiece based on the workpiece data input 730 corresponding to the characteristics of the workpiece.

Many modifications and other embodiments will come to mind to one skilled in the art to which these embodiments pertain having the benefit of the teachings presented in the foregoing descriptions and the associated drawings. Therefore, it is to be understood that modifications and other embodiments are intended to be included within the scope of the appended claims. Although specific terms are employed herein, they are used in a generic and descriptive sense only and not for purposes of limitation.

That which is claimed:

1. A method of forming a cut through a workpiece by a plasma arc torch, comprising:
selecting a standoff distance defined between an end of a nozzle of the plasma arc torch and the workpiece and cutting through the workpiece with the plasma arc torch at the selected standoff distance so as to produce a rounded lip at a top of the cut having a radius substantially matching a desired radius, and
selecting a non-zero angle of inclination between a center axis of the plasma arc torch and a normal to a top surface of the workpiece, wherein the cutting step is performed with the torch oriented at the selected angle of inclination so as produce a resultant cut angle substantially matching a desired cut angle.

2. The method of claim 1, wherein the step of selecting the angle of inclination comprises:
selecting a test angle of inclination;
cutting through the workpiece with the plasma arc torch oriented at the test angle of inclination, and determining the resultant cut angle produced; and
adjusting the test angle of inclination by an adjustment angle to compensate for any difference between the desired cut angle and the resultant cut angle.

3. The method of claim 2, wherein the test angle is substantially zero with respect to the normal to the top surface of the workpiece and the adjustment angle is equal in magnitude to the resultant cut angle but opposite in direction with respect to the normal to the workpiece.

4. The method of claim 1, wherein the desired cut angle is substantially zero with respect to the normal to the top surface of the workpiece.

5. The method of claim 1, further comprising increasing the standoff distance to increase the radius of the lip.

6. The method of claim 1, further comprising increasing the standoff distance and increasing an arc power to increase the radius of the lip.

7. The method of claim 1, further comprising increasing the standoff distance and decreasing a shield gas flow rate to increase the radius of the lip.

8. The method of claim 1, further comprising decreasing the standoff distance to decrease the radius of the lip.

9. The method of claim 1, further comprising decreasing the standoff distance and decreasing an arc power to decrease the radius of the lip.

10. The method of claim 1, further comprising decreasing the standoff distance and increasing a shield gas flow rate to decrease the radius of the lip.

11. The method of claim 1, wherein the selected angle of inclination and standoff distance cause the resultant cut angle to have a non-zero magnitude with respect to the normal to the top surface of the workpiece.

12. A method of cutting through a workpiece with a plasma arc torch so as to produce a rounded lip facilitating adhesion of a coating thereto, comprising:
cutting with the plasma arc torch set at a selected standoff distance between an end of a nozzle of the plasma arc torch and the workpiece so as to give the rounded lip a radius substantially matching a desired radius.

13. The method of claim 12, further comprising tilting the plasma arc torch at an angle of inclination, so as to produce a resultant cut angle substantially matching a desired cut angle.

14. The method of claim 13, wherein the angle of inclination compensates for any difference between the desired cut angle and the resultant cut angle.

15. A method of cutting through a workpiece with a plasma arc torch so as to produce a cut with a resultant cut angle defined with respect to a normal to a top surface of the workpiece, comprising:
selecting a standoff distance between an end of a nozzle of the plasma arc torch and the workpiece;
selecting a non-zero angle of inclination of a center axis of the plasma arc torch relative to the normal to the top surface of the workpiece; and
cutting the workpiece with the plasma arc torch set at the selected standoff distance and oriented at the selected angle of inclination so as to substantially match the resultant cut angle with a desired cut angle, and such that the resultant cut angle differs from the selected angle of inclination.

16. The method of claim 15, wherein the selected standoff distance results in the workpiece having a radius at a top of a lip of the cut, and further comprising selecting an arc power based on a desired radius, and operating the torch at the selected arc power.

17. The method of claim 15, wherein the selected standoff distance results in the workpiece having a radius at a top of a lip of the cut, and further comprising selecting a shield gas flow rate based on a desired radius, and operating the torch at the selected shield gas flow rate.
